(19) United States
(12) Patent Application Publication
(10) Pub. No.: US 2010/0150555 A1
(43) Pub. Date: Jun. 17, 2010

(54) Automatic polarization demultiplexing for polarization division multiplexed signals

(76) Inventors: Zinan Wang, Holmdel, NJ (US); Chongjin Xie, Morganville, NJ (US)

Correspondence Address: Alcatel-Lucent USA Inc.;Docket Administrator, Room 2F-192, 600 Mountain Avenue, Murray Hill, NJ, 07974-0636, US

(21) Appl. No.: 12/316,432

(22) Filed: Dec. 12, 2008

(51) Int. Cl. H04J 14/06

(52) U.S. Cl. 398/65

(57) ABSTRACT

Method and apparatus are provided for polarization demultiplexing for a Polarization Division Multiplexed (PDM) signal stream in the optical domain. The optical PDM signal stream includes a first channel representing a first data stream and a second channel representing a second data stream, a time delay between the first channel and the second channel. A Polarization Beam Splitter (PBS) demultiplexes an optical PDM signal into the first channel and the second channel. An associated processing block obtains one of the channels and provides a Polarization Controller with for a control signal corresponding to the power level of the low frequency portion of the RF spectrum of the channel obtained. Based on the control signal, the Polarization Controller adjusts a state of polarization of the optical PDM signal stream that is provided to the PBS for demultiplexing.

### FIELD OF THE INVENTION

The invention relates to optical transmission systems, and, in particular, to systems, apparatuses and methods for polarization demultiplexing of polarization division multiplexed signals.

### BACKGROUND INFORMATION

Polarization division multiplexing (PDM), which simultaneously transmits two channels of an identical wavelength in orthogonal states of polarization (SOPs), can double the spectral efficiency of a fiber-optic communication system. However, since the SOP of a signal changes randomly with wavelength and time and cannot be maintained in a transmission link, automatic polarization demultiplexing must be performed at the receiver side to separate the two polarization-distinguished channels. Automatic polarization demultiplexing may occur either in the electronic domain for coherent detection or in the optical domain for direct detection.

Electronic polarization demultiplexing in coherent detection requires high-speed digital signal processing and is dependent on bit rates. For high bit rate systems, such as 100 Gb and higher, electronic polarization demultiplexing is a difficult task. Optical polarization demultiplexing presents its own challenges. For example, one issue optical polarization demultiplexing attempts to address is Polarization Dependent Loss (PDL). PDL is a measure of the peak-to-peak difference in transmission of an optical component or system with respect to all possible states of polarization. The output power variation is the result of the variation in the polarization of the incident light wave signal, commonly the effect of dichroism, fiber bending, angled optical interfaces and oblique reflection. In passive optical components, PDL varies as the polarization state of the propagating wave changes.

Prior techniques for automatic demultiplexing include: imposing radio-frequency (RF) tones at the transmitter side using amplitude modulation, phase modulation or frequency modulation to identify the two polarizations; using different power levels for the two polarizations at the transmitter; and using RF power over the whole RF signal bandwidth as a feedback signal. However, each of these techniques suffers from at least one of the following drawbacks: extra non-linear penalty is induced for the signal at one of the polarizations before transmission; the transmitter needs to be delicately designed to impose physical differences between channels; PDL causes large crosstalks between channels; and high-speed electronics are needed to process the demultiplexing control signal.

### SUMMARY OF THE INFORMATION

A method and apparatus for automatic polarization demultiplexing for optical Polarization Division Multiplexed (PDM) signals in optical domain is provided. Advantages of the method and apparatus include one or more of not requiring special treatment of the signals at the transmitter side, requiring only low frequency electronics to control the demultiplexing process, and reducing crosstalk caused by PDL. Further, the provided optical polarization demultiplexing method also may be advantageously almost independent of bit rates. As compared with the requirements of electronic polarization demultiplexing in coherent detection, ones of these benefits may be desirable in some high capacity applications.

An exemplary method includes receiving an optical Polarization Division Multiplexed (PDM) signal stream. The optical PDM signal stream includes a first channel representing a first data stream and a second channel representing a second data stream with a predetermined time delay between the first channel and the second channel. The exemplary method further includes demultiplexing the optical PDM signal stream into the first channel and the second channel and controlling a state of polarization of the optical PDM signal stream based on a power level of a low frequency portion of the RF spectrum of one of the first channel and the second channel.

In another embodiment, the state of polarization of the optical PDM signal stream is adjusted so as to minimize the power level of the low frequency portion. Controlling the state of polarization may also include aligning the optical PDM signal stream provided to the demultiplexing step.

In one embodiment, controlling the state of polarization includes photodetecting a respective port of the polarizatiom beam splitter, low pass filtering the signal that was photodetected in order to obtain a low frequency portion of the RF spectrum, and adjusting the state of polarization of the optical PDM signal stream based on that low frequency portion. In another embodiment, controlling the state of polarization includes low-speed photodetecting a respective one of the first channel and the second channel to obtain the low frequency portion of the RF spectrum and adjusting the state of polarization of the optical PDM signal stream based on that low frequency portion.

Further embodiments may include converting the low frequency portion into a control signal which corresponds to the power level of the low frequency portion and controlling the state of polarization of the optical PDM signal stream based on the control signal. Controlling the state of polarization may also include amplifying the low frequency portion in another embodiment.

In one embodiment, at least one of the first channel and the second channel is decoded to recover a corresponding data stream. In some embodiments, the low frequency portion includes frequency components between approximately 10 KHz and approximately 1 MHz. In other embodiments, the low frequency portion includes frequency components below approximately 500 MHz. In one embodiment, the predetermined time delay between the first channel and the second channel is at least 3 ns. In other embodiments, the time delay is at least 1000 ns. Insertion of a predetermined delay above a threshold between the two polarizations at the transmitter serves to concentrate the optical signal in the low frequency range such that, the RF power in the low frequency range can be used as feedback control with improved accuracy and response time. Increasing the delay between polarizations concentrates a greater portion of the optical signal in the low frequency component.

An exemplary apparatus according the invention includes a Polarization Controller (PC), a Polarization Beam Splitter (PBS), and a processing block. The PC adjusts a state of polarization of an optical Polarization Division Multiplexed (PDM) signal stream in response to a control signal. The optical PDM signal stream includes first channel representing first data stream and a second channel representing a second data stream, with a predetermined time delay between the first channel and the second channel. The output of the PC is connected to the PBS which demultiplexes the optical PDM signal stream into the first channel and the second channel. The processing block is connected with the PBS for obtaining the mixing information between the first channel and second channel. The processing block determines and provides the control signal to the PC for adjusting the state of polarization of the optical PDM signal. The control signal corresponds to a power level of the low frequency portion of the mixing between the first channel and the second channel. The control signal is an adjustment instruction that seeks to adjust, via the PC, the state of polarization of the optical PDM signal stream so as to minimize the power level of the low frequency portion. This feedback loop provides a polarization control signal to the PC based on the RF power of the low frequency portion of the mixing between the two channels. The control signal is generated so as to attempt to minimize the RF power. The power level of the particular range of the RF spectrum can be treated as a direct indication of the misalignment between the PDM signals and the PBS with the PC continually adjusted before the PBS to minimize the RF signal.

For a given phase mismatch, the power of the RF spectrum depends on the angle between the SOP of one of the channels and the polarizer at an input port of the PBS. When that angle is 0 degrees or 90 degrees, the power of the RF spectrum is minimal, and when that angle is 45 degrees, the power of the RF spectrum is maximal. With increased delay line length between the two polarizations at the transmitter, the RF power difference between an optical PDM signal that is misaligned with the PBS versus an aligned optical PDM signal becomes more pronounced at the low frequency range of the received optical PDM signal. In one embodiment, the time delay between the first channel and the second channel of the received optical PDM signal is at least 3 ns. In another embodiment, the time delay is at least 1000 ns. In one embodiment, the low frequency portion includes frequency components between approximately 10 KHz and approximately 1 MHz. In another embodiment, the low frequency portion includes frequency components below approximately 500 MHz.

In one embodiment, the processing block includes a photodetector, low pass filter, an RF power detector, and a control circuit. The photodetector is adapted to obtain one of the first channel and the second channel. The low pass filter is adapted to filter the photodetected signal to obtain a low frequency portion. The RF power detector is adapted to determine a power level for the low frequency portion, and the control circuit is adapted to generate a control signal that corresponds to the power level of the low frequency portion. The processing block may also include an amplifier that is adapted to amplifying the low frequency portion prior to providing the low frequency portion to the RF detector.

A further embodiment of the apparatus may include a receiver connected to the PBS. The receiver is adapted to decode one of the channels in order to recover a corresponding data stream.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 is a exemplary block diagram of an transmitter according to the principles of the invention;

FIG. 2 is a exemplary block diagram of receiver according to the principles of the invention;

FIGS. 3a and 3b are sample graphs illustrating a calculated RF Spectrum for a PDM signal that is 0 degree aligned with a PBS and with any time delay between channels/polarizations as compared to a PDM signals 45 degrees aligned with the PBS and having various delay line lengths between the polarizations; and

FIGS. 4a and 4b are enlarged version of a low frequency portion of FIGS. 3a and 3b respectively.

### DETAILED DESCRIPTION

Various example embodiments will now be described more fully with reference to the accompanying figures in which like numbers refer to like elements throughout the description of the figures. Specific structural and functional details disclosed herein are merely representative for purposes of describing example embodiments. Example embodiments may be embodied in many alternate forms and should not be construed as limited to only the embodiments set forth herein.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. The term “and” is used herein in the disjunctive and conjunctive senses to mean any and all combinations of one or more of the associated listed items, and the singular forms “a”, “an” and “the” are intended to include the plural forms as well, unless the context clearly indicates otherwise. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

It should also be noted that in some alternative implementations, the functions/acts noted for exemplary methods may occur out of the order noted in the figures. For example, two figures shown in succession may in fact be executed substantially concurrently or may sometimes be executed in the reverse order, depending upon the functionality/acts involved.

All of the functions described above with respect to the exemplary method are readily carried out by a general purpose computer or digital information processing device acting under appropriate instructions embodied, e.g., in software, firmware, or hardware programming. Alternatively, the described functions may be carried out by a special purpose computer. For example, functional modules can be implemented as an ASIC (Application Specific Integrated Circuit) constructed with semiconductor technology and may also be implemented with FPGA (Field Programmable Gate Arrays) or any other hardware blocks.

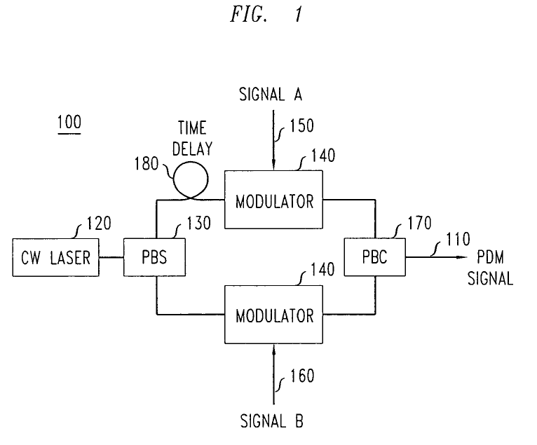

FIG. 1 is an exemplary block diagram of a transmitter according to the principles of the invention. FIG. 1 shows one conceptual diagram embodiment of a polarization division multiplexed (PDM) transmitter 100. The PDM transmitter generates a PDM signal 110 that includes two orthogonal channels A and B, which are from the same continuous wave (CW) laser 120. Polarization beam splitter (PBS) 130 splits the CW carrier with for example, equal power. The polarization beam splitter splits the incident beam into two beams of differing polarization. Then the two parts of the CW carrier are modulated by modulator 140 with signal A 150 and signal B 160 respectively. The method of modulation may be non-return-to zero (NRZ) on-off-keying (OOK), differential phase-shift keying (DPSK), quadrature phase shift keying (QPSK), or any other modulation scheme.

Further, the modulated channel that is provided may be Polarization-Division-Multiplexed (PDM) OOK, PDM-DPSK, PDM Quadrature Amplitude Modulated (QAM), or some combination thereof. For example, the modulated channel may be a PDM-QAM channel. In addition, OOK channels and phase-shift-keying (PSK) channels may be generated such that WDM channels that are combinations of OOK channels and PSK channels are provided.

In FIG. 1, before the two channels are multiplexed at the polarization beam combiner (PBC) 170, a time delay 180 sets a differential time delay of a predetermined amount between the carriers for the two branches prior to modulation. Alternatively, one of the channels may be delayed after modulation and prior to combination by the PBC. In other words, in some manner a delay is introduced in optical path between signal A and B. The PBC combines the two polarized beams by a simple technique for combining (i.e., superimposing) two linearly polarized beams. For example, the two beams, one vertically polarized and the other horizontally polarized, can be sent onto a thin-film polarizer such that one of the beams is reflected, the other one transmitted, and both beams then propagate in the same direction. As a result, an unpolarized beam having the combined optical power of the input beams (disregarding some parasitic losses) and the same beam quality is obtained.

Insertion of a predetermined time delay in the optical path of one of the channels serves to concentrate RF power of the mixing between the two polarizations of the PDM signal in lower frequencies, for example, in frequencies below approximately 500 MHz or below 1000 MHz. In one embodiment, the time delay inserted into the optical path between channels is at least 3 ns. In another embodiment, the time delay between the first channel and the second channel of the resultant optical PDM signal is at least 1000 ns. The transmitter receives a first data stream (signal A) and a second data stream (Signal B), modulates the first data stream and the second data stream with a carrier thereby forming a first channel and a second channel wherein the polarization of the first channel and the polarization of the second channel are orthogonal. Either the carrier for one of the channels is delayed before modulation or a modulated channel is delayed to form a first delayed channel, and the first delayed channel multiplexed with the second channel by PBC, thereby forming an optical PDM signal. The PDM signal is transmitted across a transmission link (not shown) to an optical PDM receiver.

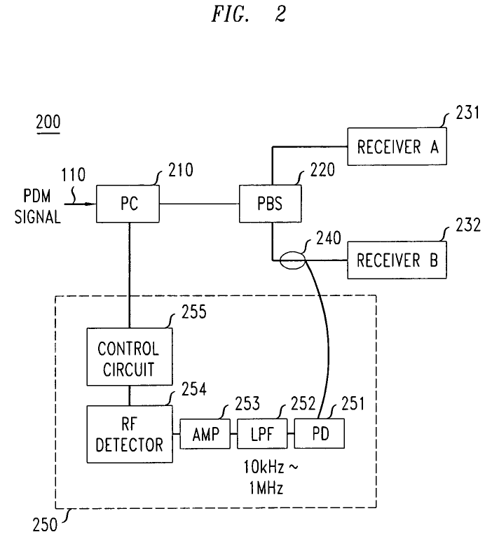

FIG. 2 is an exemplary block diagram of a receiver according to the principles of the invention. FIG. 2 shows one conceptual diagram embodiment of a polarization division multiplexed (PDM) receiver 200. The PDM receiver receives a PDM signal 110 that includes two orthogonal channels A and B with a first channel representing first data stream and second channel representing a second data stream, with a predetermined time delay between the first and second channels. That is; the received optical PDM signal represents two channels with a time delay between the channels representing data streams. The PDM signal is provided to a polarization controller (PC) 210. The PC converts any input state of polarization (SOP) to any selectable output state of polarization, for example, by the application of voltage to independently controlled retardation plates. Typical polarization controller devices use electro-optic materials to enable high-speed, solid-state polarization conversions in a compact package.

The PC is connected to polarization beam splitter (PBS) 220. The PC provides the optical PDM signal to the PBS. The PC is capable of adjusting a SOP of the optical PDM signal stream in response to a control signal. The PC functions to ensure the SOP of the PDM signal is aligned to the PBS as the optical PDM signal is provided to the PBS. PBS 220 demultiplexes the incident PMD signal into two channel beams of differing polarization. A first of the channels is provided to receiver A 231 for decoding of the data stream A. A second of the channels is provided to receiver B 232 for decoding of data stream B. The receivers are adapted to decode the received channels in order to recover a corresponding data stream.

Coupler 240 delivers one of the channels to processing block 250 for generation of a feedback signal to control the PBS, thus providing automatic polarization demultiplexing for the PDM signal in the optical domain. The processing block provides the PC with a control signal based on the coupled PDM signal from one port of the PBS for adjusting the state of polarization of the optical PDM signal. The control signal that is provided by the processing block corresponds to a power level of the low frequency portion of the one of the first channel and the second channel.

In FIG. 2, coupler 240 provides channel B to processing block 250 for feedback control of the PC and thus the optical PDM signal provided to the PBS. Coupler 240 provides channel B to photodetector (PD) 251. The PD is a device used for conversion of an optical signal to an electrical signal. As the requirements may vary considerably concerning wavelength, maximum optical power, dynamic range, linearity, quantum efficiency, bandwidth, size, robustness and cost, there are many types of photodetectors which may be appropriate in a particular case. In one embodiment, the photodetector is a photodiode, a semiconductor device where light is absorbed in a depletion region and photocurrent generated. Such devices can be very compact, fast, highly linear, and exhibit high quantum efficiency and a high dynamic range, provided that they are operated in combination with suitable electronics. The photodetector converts the received optical signal into another form, in this case from an optical to an electrical signal.

The electrical signal output by the PD 251 is connected to a low-pass filter (LPF) 252, which is adapted to filter the photodetected channel to obtain a low frequency portion. In one embodiment, LPF filters a low frequency portion that includes frequency components between approximately 10 KHz and approximately 1 MHz. In another embodiment, the LPF filters a low frequency portion that includes frequency components below approximately 500 MHz.

The output of the LPF 252 is connected RF power detector 254. The RF detector is adapted to determine a power level for the low frequency portion. Optionally, the low frequency portion may be amplified by amplifier 253 before being supplied to the RF power detector. The detected RF power is provided to control circuit 255. The control circuit is adapted to generate a control signal that corresponds to the power level of the low frequency portion. The control signal is an adjustment instruction that seeks to adjust, via the PC, the state of polarization of the optical PDM signal stream so as to minimize the power level of the low frequency portion. Thus, a feedback loop is provided.

The feedback loop provides a polarization control signal to the PC based on the RF power of a portion of the one of the channels. The control signal is generated so as to attempt to minimize RF power. The power level of the particular range of the RF spectrum selected by the LPF can be treated as a direct indication of the misalignment between the PDM signals and the PBS with the PC continually adjusted before the PBS to minimize the RF signal.

In another embodiment of the processing block at the receiver, a low speed photo-detector (not shown) is used to convert the optical signal from the coupler 240 to an electrical signal. In this embodiment, the low frequency portion is then provided to RF power detector 254 for further generation of the feedback signal to control the polarization demultiplexer. For example, the low speed photo-detector may convert optical signals below 1 MHz or below 500 MHz to electrical signals. In this manner the necessity of a separate low-pass filter is eliminated. It should be noted once again that optional amplification of the low frequency portion may be employed.

When the SOP of the optical PDM signal is misaligned at the PBS, the PDM signal will not be split perfectly and the optical field at an output port of the PBS will include components of both polarizations. The optical field at an output port of the PBS will depend upon the modulation envelope of both of the channels, the angle between the SOP of one channel and the polarizer at the output port of the PBS, the amplitude of the optical field of both channels, the center frequency of the carrier, and random phase fluctuation. Further, when the optical field at the output port of the PBS is photoconverted to a photo-current, the power spectrum of the photocurrent may be given by the Fourier transform of its autocorrelation function. Thus, applying the Fourier transform to the first order correlation function of the photocurrent, the spectrum of the photocurrent may be determined to be equivalent to a direct intensity term, an optical beating term and a shot noise term. Disregarding the minor shot noise term, the spectrum of the photocurrent can be mathematically expanded and the spectrum generated from the beating of the correlated optical carrier of the two channels can be determined.

Disregarding the minor shot noise term, the spectrum of the photocurrent can be mathematically expanded as:

$$S ( ω ) = {cos}^{2} θ {sin}^{2} θ π {σ}^{2} {E}_{0}^{4} δ ( ω ) + {σ}^{2} {E}_{0}^{4} \{ [ {cos}^{4} θ + {sin}^{4} θ + sin ( 2 θ ) cos ( {ω}_{0} {τ}_{0} ) {e}^{- \frac{Δ ω {τ}_{0}}{2}} ] {S}_{M} ( ω ) + \frac{1}{2} {sin}^{2} ( 2 θ ) {e}^{- Δ ω {τ}_{0}} {S}_{M} ( ω ) ⊗ {S}_{M} ( ω ) ⊗ {S}_{corr} ( ω ) \}$$

wherein s(ω) is the spectrum of the photo-current. The first term of this equation for the spectrum of the photocurrent represents the DC term, the second term represents the beating term wherein:
θ is the angle between the state of polarization of channel A and the polarizer at port A;
E₀ is the amplitude of the optical fields of each channel;
σ is the photo-detector responsivity;
ω₀ is the center frequency of the optical carrier;
τ₀ is the differential time delay between the two channels;
δ(ω) is the Dirac function;
Δω is the laser linewidth;
[symbol] is convolution operation;
S_{M}(ω) is the spectrum of the modulation envelope which can be expressed as

S_{M}(ω)=∫₂₈²⁸<M_{A}(t)M_{A}(t+τ)>e^{-jωτ}dτ

wherein t is time and τ is the correlation time, <□> represents averaging over time; and
S_{corr}(ω) is the spectrum generated from the beating of the correlated optical carrier of the two channels which can be expressed as

$${S}_{corr} ( ω ) = 4 π {cos}^{2} ( {ω}_{0} {τ}_{0} ) δ ( ω ) + \frac{4 Δ ω}{{( Δ ω )}^{2} + {ω}^{2}} • \{ {cos}^{2} ( {ω}_{0} {τ}_{0} ) [ cos ( ω {τ}_{0} ) - {e}^{- Δ ω {τ}_{0}} - \frac{sin ( ω {τ}_{0} ) Δ ω}{ω} ] + cosh ( Δ ω {τ}_{0} ) - cos ( ω {τ}_{0} ) \}$$

Neglecting the direct current component, the spectrum of the photocurrent varies with the angle between the SOP of one channel and the polarizer at the output port of the PBS. It can be determined that there is a power difference of the RF spectrum between different launch angles. For a launch angle of 0 degrees or 90 degrees, the power of the RF spectrum is minimal, and for a launch angle of 45 degrees, the power of the RF spectrum is maximal. Regardless of the modulation scheme used, variation of which results in a change of the exact shape of the modulation envelope and thus a change in the spectrum of the photocurrent, there will be a power difference of the RF spectrum between different launching angles.

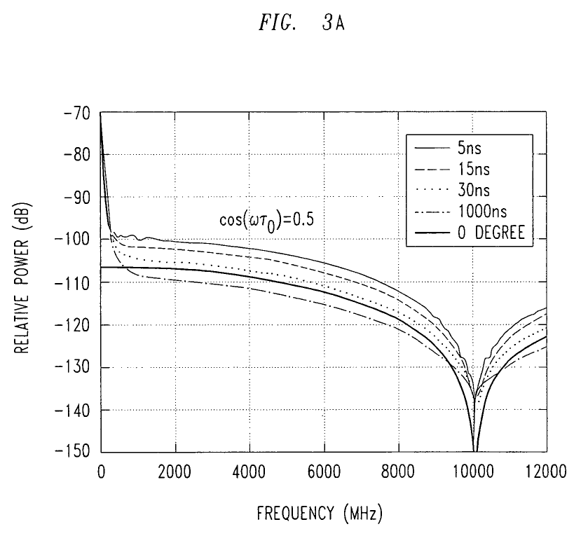

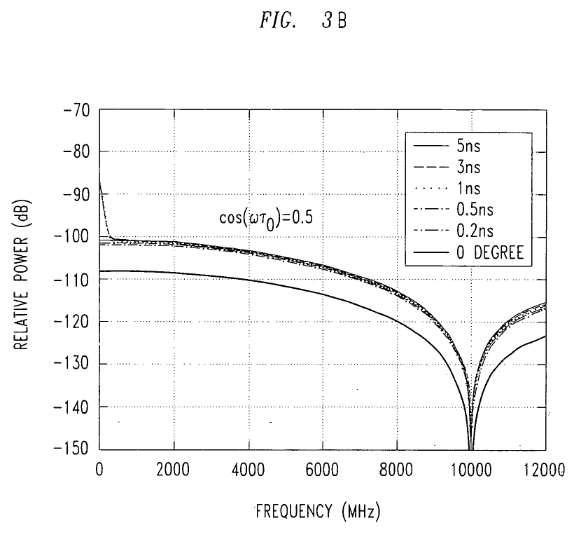

FIGS. 3a and 3b are sample graphs of a calculated RF Spectrum illustrating a PDM signal that is 0 degree aligned with a PBS and any time delay between the channels polarizations as compared to a PDM signals 45 degrees aligned with the PBS and having various delay line lengths between the polarizations. The calculated spectrum is for a 10-Gb/s Non-return-to-zero (NRZ) on-off-keying (OOK) PDM signal and assumes the phase mismatch of the optical carriers of the two channels is such that cos(ωτ₀)=0.5. Further, in the sample graphs, the amplitude of the optical fields of each channel is 1 W^{1/2}, the photo-detector responsivity is 1 A/W, the center frequency of the optical carrier is 193.55 THz, and the laser linewidth is 10 MHz.

The curve with the lowest dB level represents a PDM signal that is 0 degree aligned with the PBS. The other curves correspond to different delay line values for instances when the optical PDM signal is 45 degrees aligned with the PBS. As noted above, the RF power level is maximal when the launching angle between the PDM signal and the PBS is 45 degrees and minimal when the launching angle is 0 degrees or 90 degrees.

As illustrated in FIGS. 3a and 3b, with increased delay line length between the two polarizations at the transmitter, the RF power difference between an optical PDM signal that is misaligned with a PBS versus an aligned optical PDM signal becomes more pronounced at the low frequency range. In particular, above a threshold level of delay, the RF power spectrum becomes concentrated in the lower frequencies when the optical PDM signal is misaligned with the PBS. For example, as illustrated in FIG. 3b, when delay length is 0.2, 0.5 and 1 ns, the calculated RF spectrum appears to be flat line in the low frequency range. However, as delay line length is increased to 3, 5, 15, 30 and 1000 ns, the calculated RF spectrum in the low frequency range is also increased.

Thus, a method for automatic demultiplexing PDM signals in the optical domain, based on the processing of the inter-channel correlated fields of channels delayed relative to one another may be provided. By using the low-pass filter to select the particular range of the RF spectrum and optionally applying electrical amplification, the power level of the newly generated RF signal can be treated as a direct indication of the misalignment between the PDM signals and the PBS. Automatic demultiplexing is achieved by continually adjusting the polarization controller before the PBS to minimize the RF signal.

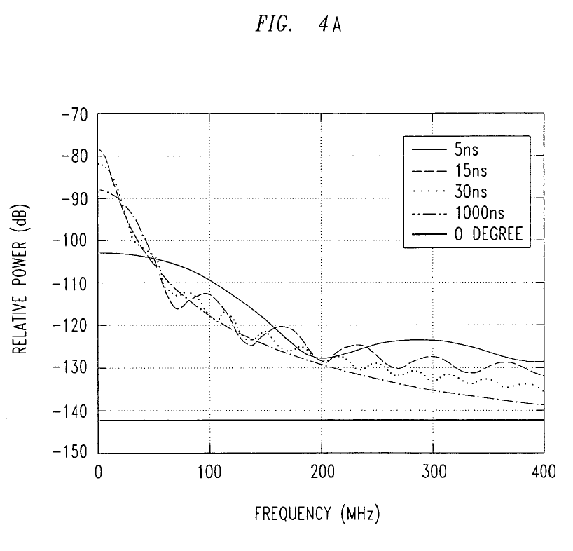

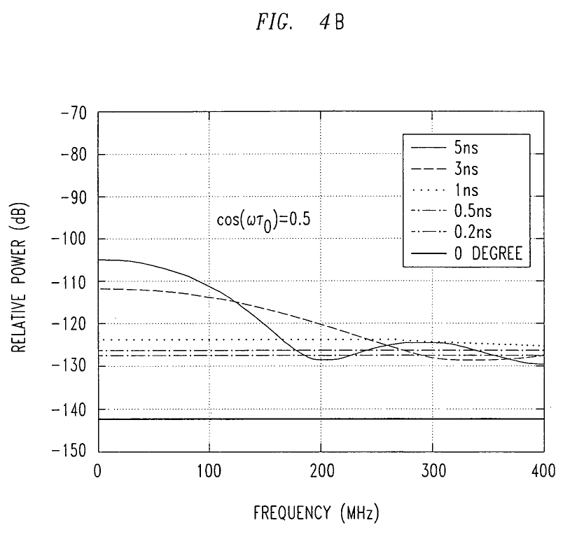

FIGS. 4a and 4b are enlarged versions of a low frequency portion of FIGS. 3a and 3b respectively. The curve (represented as a straight line) with the lowest dB level is for the case that a PDM signal is 0 degree aligned with the PBS. The other curves correspond to different delay line values (0.2, 0.5, 1, 3, 5, 15, 30 and 1000 ns) for instances when PDM signal is 45 degrees aligned with the PBS. As illustrated, as the delay line length between the two polarizations at the transmitter is increased, the RF power difference of a channel of the received optical PDM signal becomes more pronounced in the low frequency range. Above a threshold level of delay, the RF power spectrum ceases to have a constant value and varies, becoming more concentrated in the lower frequencies. Thus in one embodiment, the time delay between the first channel and the second channel is at least 3 ns. In another embodiment, the time delay is at least 1000 ns. Insertion of a predetermined delay above a threshold between the two polarizations at the transmitter serves to concentrate the RF spectrum of the beating signal in the low frequency range such that the RF power in the low frequency range can be used as feedback control with improved accuracy and response time. Further increases in the delay between polarizations concentrates additional portions of the RF spectrum of the beating signal in the RF power of the low frequency component.

An optical method and apparatus for automatic demultiplexing PDM signals with one channel of the PDM signal time delayed relative to the other channel, based on the processing of the inter-channel correlated fields is provided. Accordingly, an exemplary method of automatic polarization demultiplexing includes receiving an optical PDM signal stream that includes a time delayed first channel representing a first data stream and a second channel representing a second data stream. The optical PDM signal stream is demultiplexed into the first channel and the second channel and a state of polarization of the optical PDM signal stream is controlled based on a power level of a low frequency portion of one of the first channel and the second channel.

The state of polarization maybe controlled by adjusting the state of polarization of the optical PDM signal stream so as to minimize the power level of the low frequency portion. Controlling the state of polarization may also include aligning the optical PDM signal stream provided for demultiplexing.

In one embodiment, controlling the state of polarization may include photodetecting a respective one of the first channel and the second channel, low pass filtering the respective one of the channels that was photodetected in order to obtain a low frequency portion, and adjusting the state of polarization of the optical PDM signal stream based on that low frequency portion. A control signal may be based on the low frequency portion. Optionally, the low frequency portion may also be amplified. Note that the exact structure the RF spectrum is affected by modulation format and the time delay between the two polarizations of a PDM signal. Therefore, for different transmitters the best spectrum extraction window varies. In addition, the exemplary method may also include decoding at least one of the first channel and the second channel to recover a corresponding data stream

Various of the functions described above may be readily carried out by general purpose digital information processing devices acting under appropriate instructions embodied, e.g., in software, firmware, or hardware programming. Alternatively, various described functions may be carried out by a special purpose device and a special purpose computer. For example, various functional circuits can be implemented as an ASIC (Application Specific Integrated Circuit) constructed with semiconductor technology and may also be implemented with FPGA (Field Programmable Gate Arrays) or any other hardware blocks.

What is claimed is:

1. A method comprising:
receiving an optical Polarization Division Multiplexed (PDM) signal stream including
a first channel representing a first data stream and
a second channel representing a second data stream, a time delay between the first channel and the second channel;
demultiplexing the optical PDM signal stream into the first channel and the second channel;
controlling a state of polarization of the optical PDM signal stream based on a power level of a low frequency portion of the RF spectrum of a respective one of the first channel and the second channel.

2. The method of claim 1 wherein said controlling comprises:
adjusting the state of polarization of the optical PDM signal stream so as to minimize the power level of the low frequency portion.

3. The method of claim 1 wherein said controlling comprises:
aligning the optical PDM signal stream for said demultiplexing.

4. The method of claim 1 wherein said controlling comprises:
photodetecting the respective one of the first channel and the second channel;
filtering the respective one of the channel that was photodetected to obtain the low frequency portion; and
adjusting the state of polarization of the optical PDM signal stream based on the low frequency portion.

5. The method of claim 4 wherein said controlling further comprises:
converting the low frequency portion into a control signal corresponding to the power level of the low frequency portion; and
controlling the state of polarization of the optical PDM signal stream based on the control signal.

6. The method of claim 4 wherein said controlling further comprises:
amplifying the low frequency portion.

7. The method of claim 1 wherein said controlling comprises:
photodetecting with a low-speed photodetector the respective one of the first channel and the second channel to obtain the low frequency portion; and
adjusting the state of polarization of the optical PDM signal stream based on the low frequency portion.

8. The method of claim 1 further comprising:
decoding at least one of the first channel and the second channel to recover a corresponding data stream.

9. The method of claim 1 wherein the low frequency portion includes frequency components between approximately 10 KHz and approximately 1 MHz.

10. The method of claim 1 wherein the low frequency portion includes frequency components below approximately 500 MHz.

11. The method of claim 1 wherein the time delay between the first channel and the second channel is at least 3 ns.

12. The method of claim 1 wherein the time delay between the first channel and the second channel is at least 1000 ns.

13. An apparatus comprising:
a Polarization Controller (PC) for adjusting a state of polarization of an optical Polarization Division Multiplexed (PDM) signal stream in response to a control signal, the optical PDM signal stream including
a first channel representing first data stream and
a second channel representing a second data stream, a time delay between the first channel and the second channel;
a Polarization Beam Splitter (PBS) connected to the PC, the PBS for demultiplexing the optical PDM signal stream into the first channel and the second channel; and
a processing block connected with the PBS for obtaining one of the first channel and second channel and for providing the control signal to the PC for adjusting the state of polarization of the optical PDM signal, the control signal corresponding to a power level of a low frequency portion of an RF spectrum of the one of the first channel and the second channel.

14. The apparatus of claim 13 wherein the control signal is an adjustment instruction that seeks to adjust the state of polarization of the optical PDM signal stream so as to minimize the power level of the low frequency portion.

15. The apparatus of claim 13 wherein the processing block comprises:
a photodetector for photodetecting the one of the first channel and the second channel;
a filter connected to the photodetector, the filter for filtering a photodetected channel to obtain the low frequency portion;
an RF detector connected to the filter, the RF detector for determining a power level for the low frequency portion; and
a control circuit for generating the control signal that corresponds to the power level of the low frequency portion.

16. The apparatus of claim 13 wherein the processing block further comprises:
an amplifier for amplifying the low frequency portion, the amplifier interconnected between the filter and the RF detector.

17. The apparatus of claim 13 further comprising:
a receiver connected to the PBS, the receiver for decoding at least one of the first channel and the second channel to recover a corresponding data stream.

18. The apparatus of claim 13 wherein the low frequency portion of the photodetected signal includes frequency components between approximately 10 KHz and approximately 1 MHz.

19. The apparatus of claim 13 wherein the low frequency portion includes frequency components below approximately 500 MHz.

20. The apparatus of claim 13 wherein the time delay between the first channel and the second channel is at least 3 ns.

21. The apparatus of claim 13 wherein between the first channel and the second channel is at least 1000 ns.
